(19) United States
(12) Patent Application Publication
(10) Pub. No.: US 2006/0230793 A1
(43) Pub. Date: Oct. 19, 2006

(54) Method for manufacturing an optical fiber preform by mcvd

(76) Inventors: Choon-Keun Hong, Seoul (KR); Byung-Yoon Kang, Gyeonggi-do (KR); Dong-Wook Lee, Gyeonggi-do (KR); Byung-Chul Kang, Daegu (KR)

Correspondence Address: JONES DAY, 222 EAST 41ST ST, NEW YORK, NY, 10017, US

(21) Appl. No.: 10/534,589

(22) PCT Filed: May 30, 2003
(86) PCT No.: PCT/KR03/01069

§ 371 Date: Mar. 22, 2006

(30) Foreign Application Priority Data
Nov. 7, 2002 (KR) 10 2002-0068943
May 13, 2003 (KR) 2003-0030247

(51) Int. Cl. C03B 37/018

(52) U.S. Cl. 65/417; 65/419

(57) ABSTRACT

Disclosed is a method for manufacturing an optical fiber preform in MCVD, which simultaneously performs an etching process for injecting a reaction gas for etching into a tube and a collapsing process for heating and collapsing the tube in order to minimize or eliminate an index dip existing at the center of the preform core. By using this method, the index dip phenomenon of the optical fiber preform can be minimized or eliminated, so it is possible to make an optical fiber having improved optical characteristics, particularly having improvement in a bandwidth and a polarization mode dispersion (PMD).

### TECHNICAL FIELD

The present invention relates to a method for manufacturing an optical fiber preform by Modified Chemical Vapor Deposition (MCVD), and more particularly to a method for manufacturing an optical fiber having improved optical characteristics by eliminating an index dip generated during processing. Especially, by using this method, it is possible to manufacture a multi-mode optical fiber capable of several gigabit transmissions without other subsidiary materials.

### BACKGROUND ART

FIG. 1a is a flowchart showing a method for making an optical fiber preform according to a conventional MCVD.

In general, an optical fiber preform is manufactured through a depositing process 100 and a collapsing process 200 to 400. The collapsing process more particularly includes a collapsing process 200, an etching process 300, and a closing process 400.

A method for making an optical fiber preform is classified into an outside deposition manner and an inside deposition manner, as well known in the art.

In case of the inside deposition manner, reaction gas such as SiCl₄, GeCl₄, POCl₃ is injected into a quartz tube together with He, O₂ by means of a technique such as MCVD. Then, the tube is heated by a torch so as to cause deposition on the inner surface of the quartz tube by way of thermal oxidation in the quartz tube, thereby forming a cladding layer and a core layer.

When the cladding layer and the core layer are formed through the above process, a hollow portion exists in the quartz tube. Thus, there is a need for a collapsing process for collapsing the quartz tube by applying heat from outside.

On the other hand, in this collapsing process, since the quartz tube in which deposition of the core is completed is heated at a temperature of 2000 to 2400° C. which is higher than that of the depositing process, GeO₂, one of additives in the core, volatilizes to be GeO.

Accordingly, the concentration of GeO₂ is decreased on the inner surface of the deposited core layer, thereby generating an index dip, i.e., a drop of the refractive index at the center of the core, as shown in FIG. 7. Sometimes, the volatilized GeO gas is converted again into GeO₂ in front of the heat source and then dispersed into the core, so an index peak at which the refractive index rises up again at the core center may be generated, as can be seen from FIG. 8.

The index dip, the index peak and resultant irregularity of the refractive index may deteriorate the microbending loss and PMD (Polarization Mode Dispersion) of the single mode fiber due to the increase of the potential stress caused by asymmetry of the refractive index and may significantly decrease a bandwidth and a differential mode play in the multimode.

Thus, in order to eliminate such portions having a low refractive index, the etching process 300 for flowing an etching gas thereto is progressed about two times, and then the closing process 400 for eliminating the hollow space of the quartz tube to have a quartz rod shape is executed.

FIG. 4a schematically depicts the etching process. Here, an etching gas such as HF or fluorine is injected into the quartz tube so as to etch the portions having a low refractive index.

FIG. 5 schematically depicts the closing process. During this process, the hollow space in the quartz tube entirely disappears, and an optical fiber preform of a quartz rod shape is made. A final optical fiber is fabricated by drawing the preform, as shown in FIG. 6.

However, volatilization of GeO₂ due to a high temperature may also occur in the closing process. Thus, an inner surface area of the quartz tube is preferably minimized just before the closing process in order to prevent the volatilization. In other words, it is desirable to keep the small inner diameter of the quartz tube after the collapsing process 200 in order to minimize an index dip at the center of the core.

Despite minimizing the inner diameter of the quartz tube after the collapsing process 200 however, the inner diameter is increased again during the etching process 300, so there are still limitations in minimizing or preventing volatilization of GeO₂ in the closing process.

Korean Pat. No. 10-0315475 discloses a method for making an optical fiber preform by MCVD, which includes a depositing process for forming a clad layer and a core layer, an additional depositing process for additionally forming a specific deposition layer on the deposited core layer, a collapsing process for heating the quartz tube on which the clad layer, the core layer and the additional deposition layer are formed at a higher temperature than a softening temperature so that the quartz has an adequate inner diameter, and an etching-closing process for etching the additional deposition layer together with removing an hollow portion in the quartz tube completely.

However, this patent fails to disclose a method for optimizing the inner diameter of the tube by simultaneously performing etching and collapsing before the closing process in order to minimize additional volatilization of GeO₂ generated in the closing process due to increase of the inner diameter of the tube during the etching process.

### DISCLOSURE OF INVENTION

The present invention is designed on the consideration of the above problems. Therefore, an object of the present invention is to provide a method for manufacturing an optical fiber preform which is capable of minimizing or eliminating an index dip phenomenon existing at the center of the preform core.

In order to accomplish the above object, the present invention provides a method for manufacturing an optical fiber preform by MCVD, which includes an etching/collapsing process simultaneously performing an etching process for injecting a reaction gas into a tube and a collapsing process for collapsing the tube by applying heating just before a closing process for lastly collapsing the quartz tube and making in the shape of quartz rod in order to minimize or eliminate an index dip existing at the center of the preform core.

Preferably, the reaction gas for etching is mixture gas of an etching gas and oxygen, more particularly, mixture gas of O₂ and C₂F₆, and a flow rate ratio of (O₂/C₂F₆) is 2.5 to 30.

According to the present invention, it is possible to minimize or eliminate an index dip phenomenon by improving refractive index of the optical fiber preform. By using the optical fiber preform of the present invention, it is possible to make an optical fiber having improved a bandwidth and optical characteristics, especially, to make a multi-mode optical fiber for giga-bit Ethernet.

A multi-mode optical fiber for gigabits Ethernet is optimized to a system utilizing a light source of laser by eliminating an index dip existing at the center of the prior multi-mode optical fiber core, and finely controlling a refractive index profile. For optical transmission of several gigabits data rate, differently as LED (Light Emitting Diode) used in the prior optical fiber, a light source such as FP-LD (Fabry-Perot Laser Diode) or VDSEL (Vertical Cavity Surface Emitting Laser) having small beam spot size is used. Thus, for use of such light source, there is required to finely control the refractive index profile and improve a Restricted Mode Launching Bandwidth.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1a is a flowchart for illustrating a method for making an optical fiber preform by MCVD according to the prior art;

FIG. 1b is a flowchart for illustrating a method for making an optical fiber preform by MCVD according to the present invention;

FIG. 2 is a schematic sectional view for illustrating a depositing process in MCVD;

FIG. 3 is a schematic sectional view for illustrating a collapsing process in MCVD;

FIG. 4a is a schematic sectional view for illustrating an etching process in MCVD according to the prior art;

FIG. 4b is a schematic sectional view for illustrating an etching process according to one preferred embodiment of the present invention;

FIG. 5 is a schematic sectional view for illustrating a closing process in MCVD;

FIG. 6 is a schematic sectional view for illustrating a drawing process in MCVD;

FIG. 7 is a graph showing an index dip generated inside an optical fiber drawn from the preform after the collapsing process according to the prior art;

FIG. 8 is a graph showing an index peak generated inside an optical fiber drawn from the preform after the collapsing process according to the prior art;

FIG. 9 is a graph showing a refractive index dispersion of an optical fiber drawn from the preform after the collapsing process according to the prior art; and

FIG. 10 is a graph showing a refractive index dispersion of an optical fiber produced according to one embodiment of the present invention.

### BEST MODES FOR CARRYING OUT THE INVENTION

Hereinafter, preferred embodiments of the present invention will be described in detail with reference to the accompanying drawings.

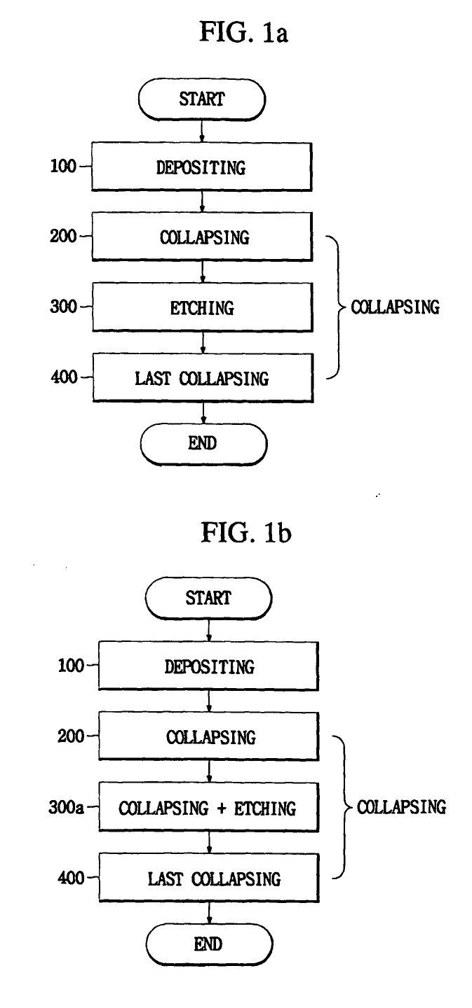

First, FIG. 1b is a flowchart for illustrating a method for fabricating an optical fiber preform by MCVD (Modified Chemical Vapor Deposition) according to the present invention.

Referring to FIG. 1b, the method for fabricating an optical fiber preform according to the present invention includes a depositing process 100, a collapsing process 200, an etching/collapsing process 300a, and a closing process 400.

Hereinafter, the method for fabricating an optical fiber preform according to the present invention is described process by process with reference to the accompanying drawings.

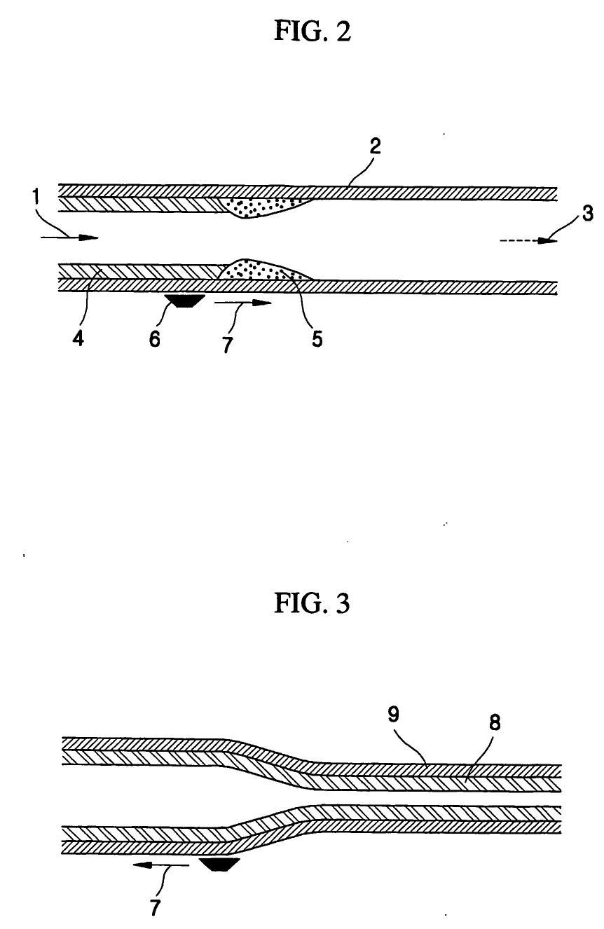

1. Depositing Process (see FIG. 2)

As shown in FIG. 2, in the depositing process, a reaction gas 1 such as SiCl₄, GeCl₄, POCl₃, He and O₂ is injected into a quartz tube 2. Then, the outside of the quartz tube 2 is heated by a torch 6 slowly moving in a longitudinal direction of the quartz tube 2.

Here, the torch 6 may have any of various shapes. For example, a variety of heat sources such as an oxygen-hydrogen torch and a plasma torch may be adopted.

The reaction gas 1 flowing through the quartz tube 2 is heated and reaches a reaction temperature at a position near to the torch 6, and then fine silica particles are generated due to oxidation reaction.

The generated particles are deposited on an inner wall of the quartz tube having relatively lower temperature in front of the torch 6. When the torch 6 moves along the whole quartz tube once, one particle deposition layer 5 is formed. At this time, in order to make an optical fiber have specific refractive index dispersion, the aforementioned process is repeated several tens times with changing the composition of the reaction gas for each layer, and then a clad/core deposition layer 4 is formed.

2. Collapsing Process (see FIG. 3)

As shown in FIG. 3, the quartz tube on which the clad/core deposition is formed during the depositing process is passed through a collapsing process 200 for collapsing the tube by applying a heat thereto from the external heat source with injecting a gas into the quartz tube.

The collapsing process 200 is performed from a gas input portion to a gas output portion along a longitudinal direction of the quartz tube.

Hereinafter, the collapsing process 200 is described in detail.

While the quartz tube on which the clad deposition layer 9 and the core deposition layer 8 are formed is rotated at a constant rotational velocity of 15˜30 rpm, the outer surface of the quartz tube is heated with a torch 6, moving from a gas input portion to a gas output portion along a longitudinal direction of the quartz tube, at a temperature of 2000 to 2400° C. which is higher than a deposition temperature.

Under such a high temperature, both inner and outer walls of the quartz tube reach a softening temperature (1600° C.). In addition, since a viscous flow is generated in the direction of the inner diameter of the quartz tube due to the difference between inner and outer pressures of the quartz tube and surface tension, both inner and outer diameters of the quartz tube are gradually decreased. In the collapsing process, the surface tension generally has a constant value within the range of 200 to 400 dyne/cm though it is slightly decreased in accordance with a temperature.

In order to collapse the hollow quartz tube, the surface tension and the difference between inner and outer pressures of the tube are used. A collapse rate is inversely proportional to the collapsing process time. On the other hand, the collapse rate is proportional to {the difference between inner and outer pressures+the surface tension}/{viscosity of the tube}. Since ovality deteriorating an optical fiber characteristics is also proportional to {the difference between inner and outer pressures+the surface tension}/{viscosity of the tube} identically to the collapse rate, the pressure difference and the tube viscosity should be suitably selected in order to reduce time required for the collapsing process to the maximum and improve the ovality of the preform. The viscosity of the tube varies as an exponential function of temperature, and the temperature of the tube is influenced by a heating time. Thus, a surface temperature and an inner pressure of the quartz tube influenced by a heating temperature and a movement velocity of the torch and a rotating velocity of the quartz tube should be set.

In the present invention, a movement velocity of the heat source is preferably kept within the range of 1˜40 mm/min, and a rotational velocity of the quartz tube at the collapsing process is preferably slower than a rotational velocity of 50 to 80 rpm at the depositing process, more preferably within the range of 15 to 30 rpm.

By heating the surface of the quartz tube, the surface temperature of the quartz tube is preferably kept within 2000 to 2400° C.

Next, a flow rate in the quartz tube is adjusted so that a difference between inner and outer pressures of the quartz tube, namely a difference between a pressure caused by temperature or gas flow in the quartz tube and a pressure of a torch flame applied from outside of the quartz tube, is kept constant.

Here, oxygen (O₂) or chlorine (Cl₂) is preferably used for adjusting a flow rate in the quartz tube. In addition, a torch used for heating also causes pressure, and the pressure of the torch flame is determined by the function having factors such as a shape of the torch and a flow velocity of gas.

In case of a multi-mode optical fiber preform having a smaller viscosity than a single-mode optical fiber preform, it is preferable to apply a small positive pressure of 0˜10 mmWC to the quartz tube so as not to transform a geometric structure of the preform and but to speed up collapsing. In case of a single-mode optical fiber preform, it is desirable to apply a negative pressure for fast collapsing.

Here, it is preferable to minimize the difference of inner and outer temperatures of the tube by flowing inert gas having a relatively higher thermal diffusivity into the quartz tube in order to prevent a collapsing velocity from decreasing. The inert gas may be selected from He and Ar, as an example.

Such a process is repeated until the inner and outer diameters of the quartz tube are reduced to a desired level, and then an etching/collapsing process 300a is progressed.

Since an ovality of the quartz tube may be deteriorated as the number of the collapsing processes is decreased, the number of the collapsing processes should be adequately set on the consideration of minimization of collapsing time and stability of the shape of the optical fiber preform, and most preferably the collapsing process is conducted four times.

According to an applicable embodiment of the present invention, the collapsing process is repeated four times, and after the collapsing process, the etching/collapsing process is performed as the fifth process, and then the closing process is performed as the sixth process.

It is preferable that a flow rate of O₂ or Cl₂ flowed into the quartz tube during the first to fourth processes is set in the range of 1.2 to 2.4 slpm. Rapid decrease of the outer diameter of the quartz tube in one collapsing process may adversely effect on optical fiber characteristics such as PMD (Polarization Mode Dispersion) due to deterioration of the ovality of an optical fiber preform. In order to prevent this problem, it is desirable to slowly reduce the flow rate of the gas.

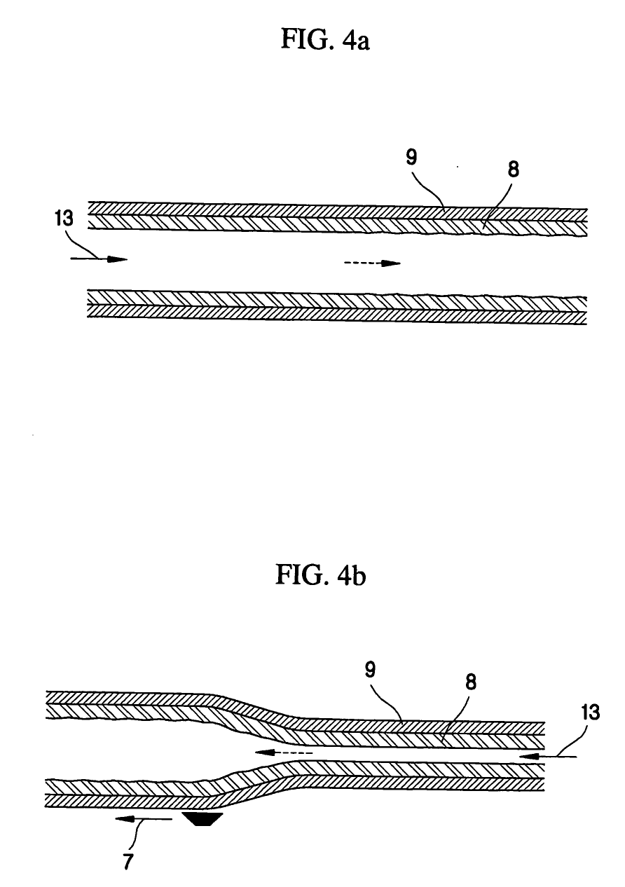

3. Etching/collapsing process (see FIG. 4b)

After the collapsing process is repeated several times as described above, the quartz tube undergoes an etching/collapsing process for simultaneously injecting an etching reaction gas and reducing an inner diameter of the core tube in order to etch a center portion of the core having a low refractive index with a reduced concentration due to volatilization of GeO₂ caused by high temperature during the collapsing process.

Here, a direction of the etching/collapsing process, a surface temperature and an inner pressure of the quartz tube are same as the above collapsing process 200.

In other words, the outer surface of the quartz tube is heated with a torch, moving from a gas input portion to a gas output portion along a longitudinal direction of the tube, at a temperature of 2000 to 2400° C. which is higher than a deposition temperature.

At this time, a movement velocity of the torch is desirably kept within the range of 1˜40 mm/min, and a rotational velocity of the quartz tube is desirably kept within the range of 15˜30 rpm.

Similarly to the collapsing process, a collapsing speed in the etching/collapsing process is also preferably slow in order to improve ovality of the optical fiber preform, and especially a collapse rate is preferably within 0.5 to 3.0 mm²/min.

A reaction gas used in the etching process is a mixture gas of an etching gas and oxygen.

More specifically, the etching gas may employ HF (Hopland, 1978, Electron. Lett., 14, 757-759) and fluorine compound of gas shape (Liegois et al., 1982, Non-Cryst. Solids, 117, 247-250; Schneider et al. 1982, Conf. Proc. Eur. Conr. Opt. Fibre Commun. 8th., 36-40).

Particularly, CCl₂F₂, SF₆, CF₄, CCl₃F, CClF₃ (GB No. 2,084,988A and FR No. 2,504,514) may be used together with O₂, and fluorine such as C₂F₆, C₃F₈ and n-C₄F₁₀ (U.S. Pat. No. 4,793,843) is preferred, and C₂F₆ is most preferred.

On the other hand, an index dip existing at the center of the core is generated due to volatilization of GeO₂ during the collapsing process. Thus, in order to remove the index dip, an etching process is conventionally performed for removal of the index dip after a collapsing process, and then a closing process is performed. However, since volatilization of GeO₂ is again generated in the closing process to form a layer having irregular refractive index at the center of the core, an index dip generated at the core center cannot be completely removed.

As an inner diameter of the preform becomes smaller in the closing process, such an irregularity at the center of the core is on the decrease. Accordingly, it is very important to minimize the inner diameter of the preform before the closing process.

However, although the inner diameter of the optical fiber preform is minimized during the collapsing process just before the closing process, the inner diameter of the preform becomes wide again during the etching process due to the inner pressure.

In the present invention, in order to remove such harmful effects, the inner diameter of the quartz tube is kept within the range of 2 to 4 mm just after the etching/collapsing process, namely just before a closing process.

In one embodiment of the present invention, a collapse rate having factors of the inner pressure and temperature, and an etching rate are adequately controlled in order to keep the inner diameter of the quartz tube constant.

At this time, the collapse rate is controlled by the surface temperature and inner temperature of the quartz tube, while the etching rate is controlled by a flow rate ratio (O₂/C₂F₆) of O₂ to the etching gas.

As previously described, it is desirable to control the collapse rate within the range of 0.5 to 3.0 mm²/min.

Preferably, a flow rate ratio (O₂/C₂F₆) of O₂ to the etching gas determining the etching rate is set within the range of 2.5 to 30. In this case, a flow rate of the etching gas is preferably within the range of 4 to 20 sccm, and a corresponding flow rate of O₂ is preferably within the range of 50 to 120 sccm.

As the inner diameter of the preform becomes smaller, an irregularity of refractive index may be minimized or eliminated, however generation of bubbles is significantly increased.

Accordingly, the inner diameter of the preform is set to have a lower limit of 2 mm in order to minimize inferiority of the preform. In addition, an upper limit of the inner diameter of the preform is set about 4 mm so that no index dip phenomenon appears in a finished optical fiber.

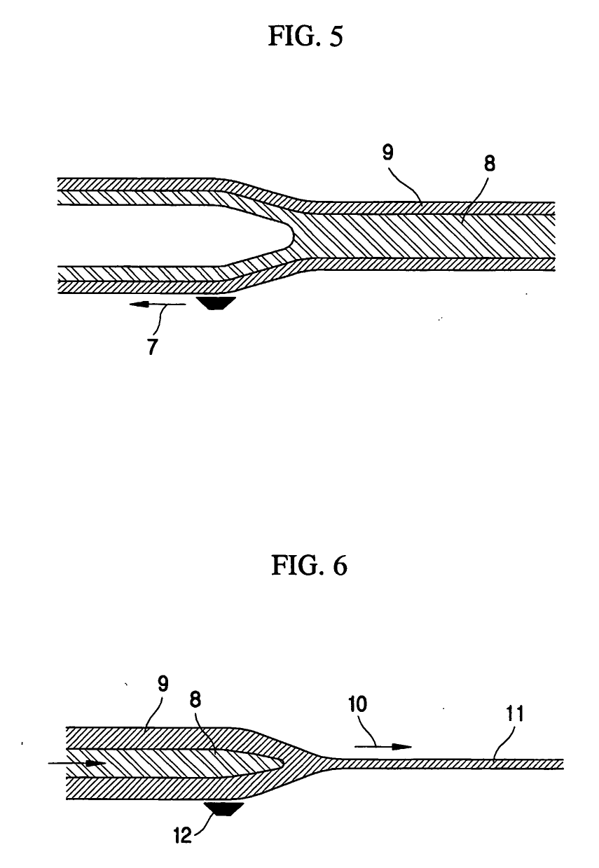

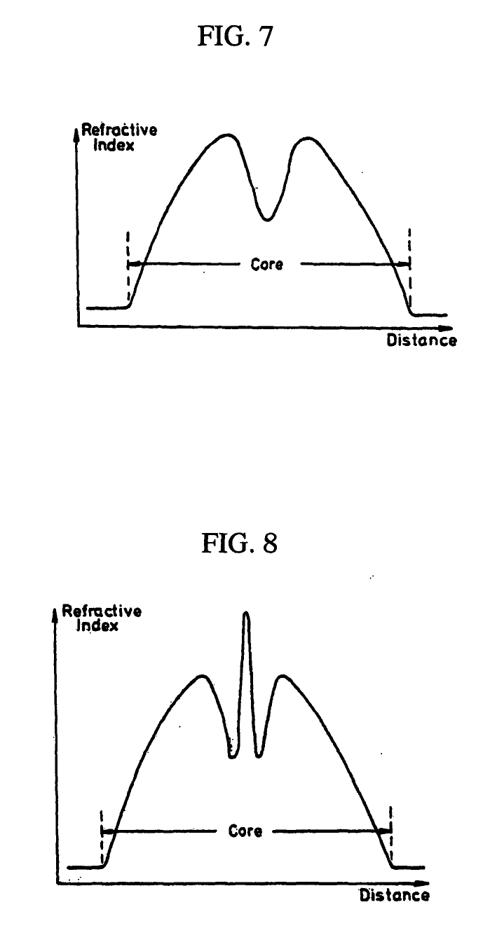

4. Closing Process (see FIG. 5)

After the etching/collapsing process 300a, a closing process 400 for eliminating the hollow portion in the quartz tube to have a quartz rod shape is executed to make an optical fiber preform.

The closing process of the present invention is progressed in the same way as the collapsing process 200.

However, the closing process is executed in an opposite direction to the collapsing process. In other words, the closing process is performed from a gas output portion to a gas input portion together with flowing a gas such as Cl₂ or O₂ into the quartz tube.

At this time, the gas plays a role of preventing volatilization of GeO₂ during the closing process, and keeping the inner pressure of the quartz tube constant to prevent the quartz tube from being abruptly collapsed, thereby improving an ovality of the optical fiber preform.

FIG. 10 is a graph showing a refractive index of an optical fiber preform core in which an index dip is removed according to the present invention.

This graph is a measured result for a refractive index of an optical fiber preform, which is obtained by completing the depositing process so that an outer diameter of the quartz tube is 33.7 mm, etching the quartz tube with a flow rate ratio (O₂/C₂F₆) of O₂ to the etching gas be 5.7 while an inner diameter of the quartz tube is kept in 2 mm at the fifth collapsing process, and then conducting the sixth collapsing process so that the quartz tube becomes a final optical fiber preform having a quartz rod shape.

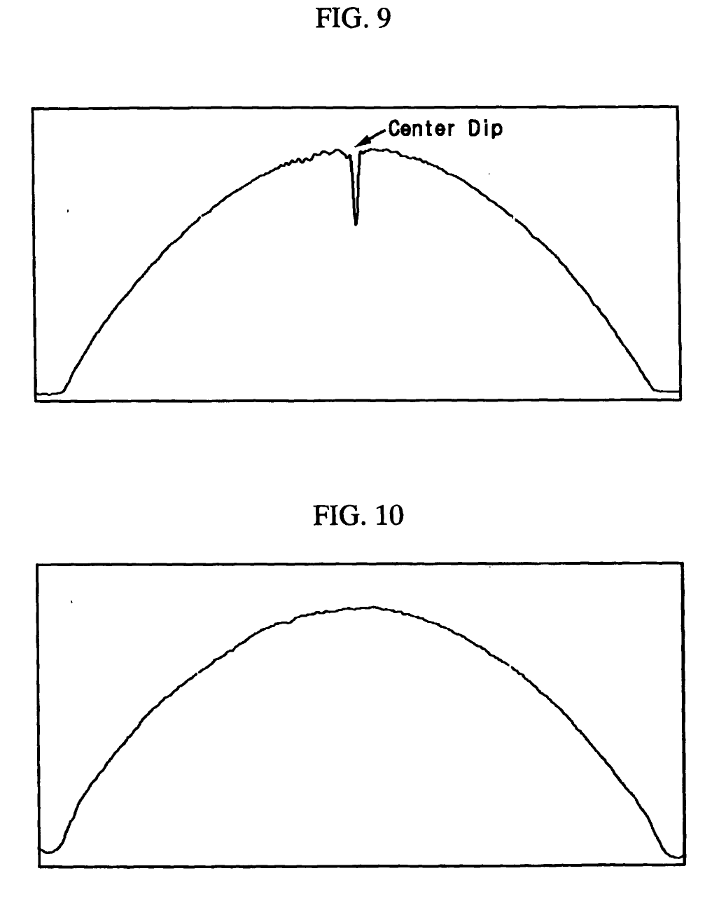

On the other hand, FIG. 9 is a graph showing a refractive index of a finished optical fiber preform according to the prior art, which is obtained by etching the quartz tube two times with flowing C₂F₆ and O₂ into the quartz tube after the fifth collapsing process, and then closing the quartz tube so that the optical fiber preform is finished. At this time, the quartz tube is not collapsed during the etching process.

As shown in FIG. 10, an index dip is completely removed by simultaneously executing the collapsing process and the etching process as proposed in the present invention.

### INDUSTRIAL APPLICABILITY

By using a method for manufacturing an optical fiber preform by MCVD according to the present invention, which simultaneously performs an etching process and a collapsing process, and then performs a closing process, an index dip phenomenon of the optical fiber preform can be minimized or eliminated, so it is possible to make an optical fiber preform having improved bandwidth and optical characteristics.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A method for manufacturing an optical fiber preform by MCVD comprising:
a depositing process for forming a clad/core deposition layer on an inner wall of a quartz tube;
a collapsing process for collapsing the quartz tube on which the deposition layer is formed by heating the quartz tube at a higher temperature than a softening temperature;
an etching/collapsing process for etching and collapsing the quartz tube at the same time by injecting an reaction gas for etching into the quartz tube together with heating the tube at a higher temperature than a softening temperature so that the inner diameter of the tube is optimized just before a following closing process; and
a closing process for forming an optical fiber preform without a hollow portion by heating the quartz tube having the optimized inner diameter at a higher temperature than a softening temperature,
whereby an index dip existing at a center of the optical fiber preform core is minimized.

2. The method for manufacturing an optical fiber preform according to claim 1,
wherein, in the etching/collapsing process, the reaction gas for etching is a mixture gas of an etching gas and oxygen, and a flow rate ratio of O₂ to the etching gas is 2.5 to 30.

3. The method for manufacturing an optical fiber preform according to claim 2,
wherein a flow rate of O₂ is 50 to 120 sccm, and a flow rate of the etching gas is 4 to 20 sccm.

4. The method for manufacturing an optical fiber preform according to claim 1,
wherein, in the etching/collapsing process, a collapse rate of the quartz tube is 0.5 to 3.0 mm²/min.

5. The method for manufacturing an optical fiber preform according to claim 1,
wherein, in the etching/collapsing process, the quartz tube is collapsed to have the inner diameter within the range of 2 to 4 mm.

6. The method for manufacturing an optical fiber preform according to claim 1,
wherein the etching/collapsing process is performed from a gas input portion to a gas output portion along a longitudinal direction of the quartz tube.

7. The method for manufacturing an optical fiber preform according to claim 1,
wherein, in the etching/collapsing process, a rotational velocity of the quartz tube is 15 to 30 rpm, a movement velocity of a heat source is 1 to 40 mm/min, and a surface temperature of the tube is 2000 to 2400° C.

8. The method for manufacturing an optical fiber preform according to claim 1,
wherein the collapsing process is performed 1 to 4 times.

9. The method for manufacturing an optical fiber preform according to claim 1,
wherein, in the collapsing process, an inner pressure of the quartz tube is kept in a positive pressure of 0 to 10 mmWC in order to make a multi-mode optical fiber preform.

10. The method for manufacturing an optical fiber preform according to claim 1,
wherein, in the collapsing process, an inner pressure of the quartz tube is kept in a negative pressure in order to make a single-mode optical fiber preform.

11. The method for manufacturing an optical fiber preform according to claim 1,
wherein the collapsing process is performed together with injecting O₂ or Cl₂ into the quartz tube.

12. The method for manufacturing an optical fiber preform according to claim 11,
wherein a flow rate of O₂ or Cl₂ is 1.2 to 2.4 slpm.

13. The method for manufacturing an optical fiber preform according to claim 1,
wherein the closing process is performed from a gas output portion to a gas input portion along a longitudinal direction of the quartz tube.

14. The method for manufacturing an optical fiber preform according to claim 13,
wherein the closing process is performed together with injecting O₂ or Cl₂ into the quartz tube.
